(19) United States
(12) Patent Application Publication
(10) Pub. No.: US 2019/0047115 A1
(43) Pub. Date: Feb. 14, 2019

(54) ELECTRIC POWER TOOL

(71) Applicant: MAKITA CORPORATION, Anjo-shi (JP)

(72) Inventors: Shin NAKAMURA, Anjo-shi (JP); Akira MIZUTANI, Anjo-shi (JP); Junya ISHIKAWA, Anjo-shi (JP)

(73) Assignee: MAKITA CORPORATION, Anjo-shi (JP)

(21) Appl. No.: 16/049,255

(22) Filed: Jul. 30, 2018

(30) Foreign Application Priority Data
Aug. 9, 2017 (JP) 2017-154100

(51) Int. Cl. B24B 47/12; B24B 23/02

(52) U.S. Cl. CPC B24B 47/12; B24B 23/02

(57) ABSTRACT

An electric power tool, for example, a polisher 1 includes a tip end tool 67a, an output shaft 65 extending in a direction perpendicular to a work surface, a main body housing 2 extending in a direction perpendicular to the output shaft 65, a motor 30 housed in the main body housing 2, and an electric circuit board 35 disposed parallel to the motor 30 in an direction in which the main body housing 2 extends.

### CROSS-REFERENCE

This application claims priority to Japanese patent application serial number 2017-154100, filed on Aug. 9, 2017, the contents of which are incorporated herein by reference in their entirety.

### TECHNICAL FIELD

The present invention generally relates to an electric power tool such as, for example, a polisher and/or an orbital sender, in which a circuit board is mounted.

### BACKGROUND ART

Variant types of grading tools and/or polishing (abrasive) tools are well known for grinding and/or polishing surfaces of an object. For example, Japanese Laid-Open Patent Publication No. 2015-174201 discloses and angle grinder 201 serving as a grinding tool (refer to FIG. 19, wherein numerals correspond to numerals in this reference figure and are not the same as the numerals of the prior art figure). Aside from said grinder, angled polishers (not sown) are also well known as a polishing tool. By using the grinder 701 or the polisher, grinding and/or polishing work on the surfaces of objects can be easily and effectively performed.

However, in the grinder 701 disclosed in Japanese Laid-Open Patent Publication No. 2015-174201, rear arrangement of a circuit board 735 with respect to a brushless motor 730 necessarily causes an increase in the total needed length of the grader 701. In addition, the angled grinder 701 includes an inlet port 718 disposed at the rear of handle housing 704 as shown in FIG. 19 and disclosed in Japanese Laid-Open Patent Publication No. 2015-174201. As a result of this structural configuration, air flow from a cooling fan 733 attached to the brushless motor 730 towards the front of the grinder, in front of the handle housing 704, may not sufficiently reach the circuit board 735 at the rear portion of grinder 701, which may place the circuit board 735 in a more vulnerable state, may prone to malfunction, since the circuit board 735 is not sufficiently cooled.

Thus, as a result of the mentioned deficiencies in the art, there is a need in the art to provide a polisher in which the local length of the device is restricted and also cooling of the circuit board can be improved and sufficiently performed.

### SUMMARY

In one exemplary embodiment of the present disclosure, a polisher comprises a tip end tool, an no tout shaft extending in a direction perpendicular to a work surface, a main body housing extending in a direction perpendicular to the output shaft, a motor that is housed in the main body housing, and an electrical circuit board that is disposed parallel to the motor in a direction in which the main body housing extends.

According to this embodiment, excessive protrusion of the polisher with the electrical circuit board can be prevented in the front-to-rear direction. Consequently, a total length of the polisher with the electrical circuit board can be shortened. In addition, air flow that is generated by driving the motor can pass through the electrical circuit board in an adequate manner, thereby meeting requirements for sufficiently cooling the electrical circuit board.

In another exemplary embodiment of the disclosure, a polisher comprises a motor with a rotor shaft that extends in a front-to-rear direction, a motor housing that houses the motor, a gear housing that is disposed at the front side of the motor, an output shaft that is held by the gear housing and disposed approximately perpendicular to the rotor shaft, a handle housing that is disposed at the rear side of the motor housing, and an electrical circuit board that is disposed further outward than the outer periphery of the motor.

According to the embodiment, the polisher can obtain the same beneficial effects as described above.

In another exemplary embodiment of the disclosure, a polisher comprises a motor with a rotor shaft that extends in a front-to-rear direction, a motor housing that houses the motor, a gear housing that is disposed at the front side of the motor, an output shaft that is held by the gear housing and disposed approximately perpendicular to the rotor shaft, a handle housing that is disposed at the rear side of the motor housing, and an electrical circuit board that is disposed between the motor and the handle housing. Furthermore, the electrical circuit board is tilted in a first-to-rear direction or disposed n perpendicular manner with respect to the front-to-rear direction.

According to this embodiment, the polisher can obtain the same beneficial effects as described above.

### BRIEF DESCRIPTION OF THE DRAWINGS

FIG. 1 is a longitudinal side view of a polisher according to a first embodiment of the present disclosure, in which an internal structure is shown in part.

FIG. 2 is a longitudinal section view of main parts of the polisher that is shown in FIG. 1.

FIG. 3 is a perspective view of a polisher according to a second embodiment of the present disclosure.

FIG. 4 is the polisher according to the second embodiment, in which an internal structure is shown in part.

FIG. 5 is a side view of the polisher shown in FIG. 3.

FIG. 6 is a side view of the polisher shown in FIG. 4.

FIG. 7 is a perspective view of a polisher according to a third embodiment of the present disclosure.

FIG. 8 is a side view of the polisher shown in FIG. 7.

FIG. 9 is a perspective view of a polisher according to a fourth embodiment of the present disclosure.

FIG. 11 is the polisher according to the fourth embodiment, in which an internal structure is shown in part.

FIG. 12 is a side view of the polisher shown in FIG. 10.

FIG. 13 is the polisher according to the fourth embodiment, in which an internal structure is shown in part.

FIG. 14 is a side view of a polisher according to a further embodiment, in which an internal structure is shown in part.

FIG. 15 is a side view of a polisher according to another further embodiment, in which the internal structure is shown in part.

FIG. 16 is a perspective view of a polisher according to another further embodiment of the present disclosure, in which an internal structure is shown in part.

FIG. 17 is a side view of the polisher shown in FIG. 16.

FIG. 18 is the polisher shown in FIG. 17, in which an internal structure is shown in part.

FIG. 19 is a longitudinal section view of a grinder according to the prior art Japanese Laid-Open Patent Publication No. 2015-174201, as described above.

### DETAILED DESCRIPTION

The detailed description set forth below, when considered with the appended drawings, is intended to be a description of exemplary embodiments of the present invention and is not intended to be restrictive and/or to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention ma be practiced without these specific details. In some instances, these specific details refer to well-known structures, components and/or devices that are shown in block diagram form in order to avoid obscuring significant aspects of the exemplary embodiments presented herein.

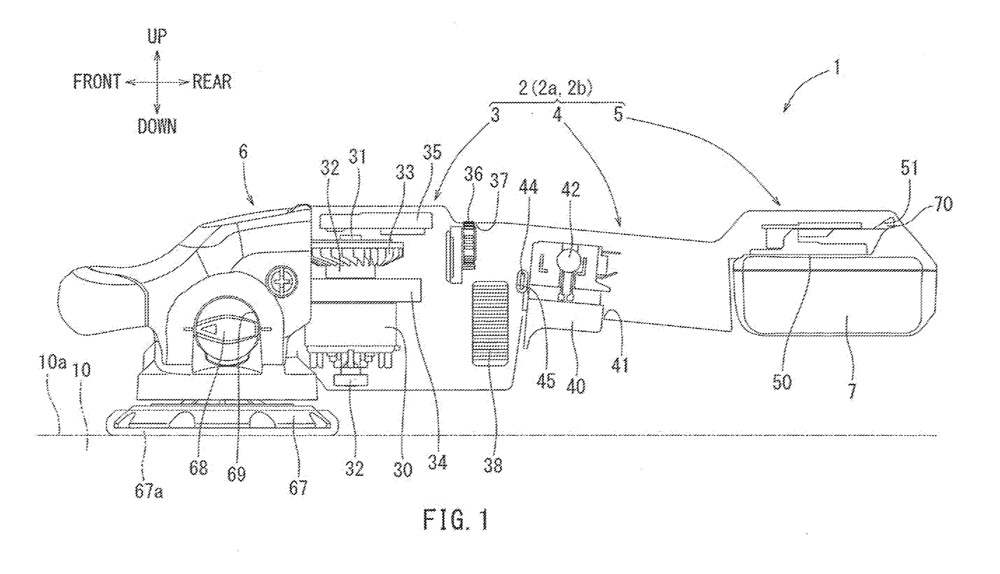

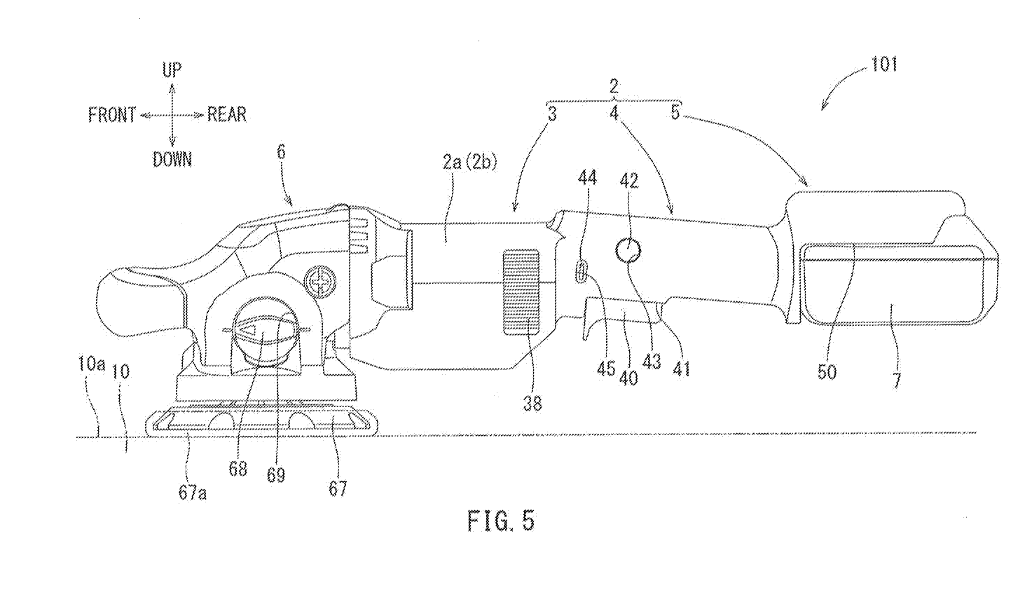

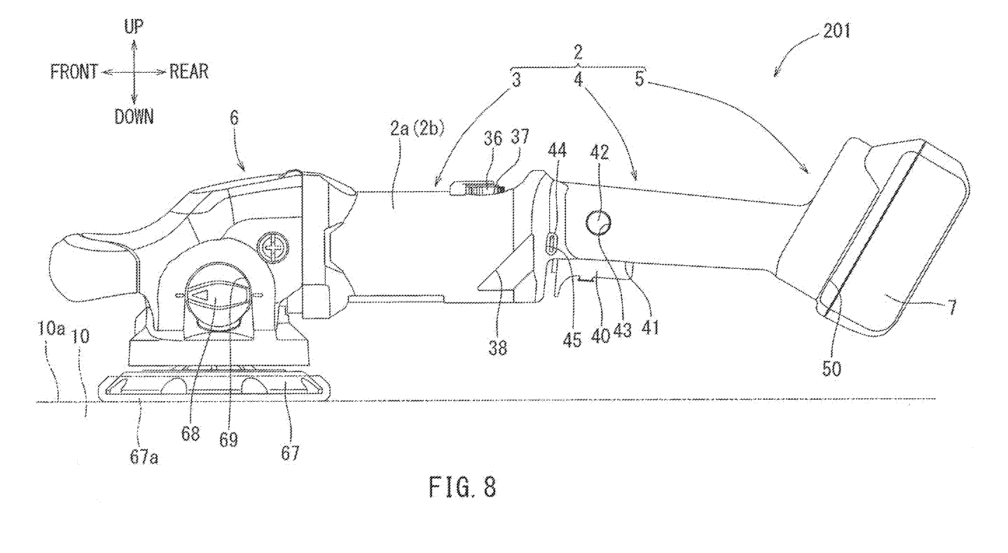

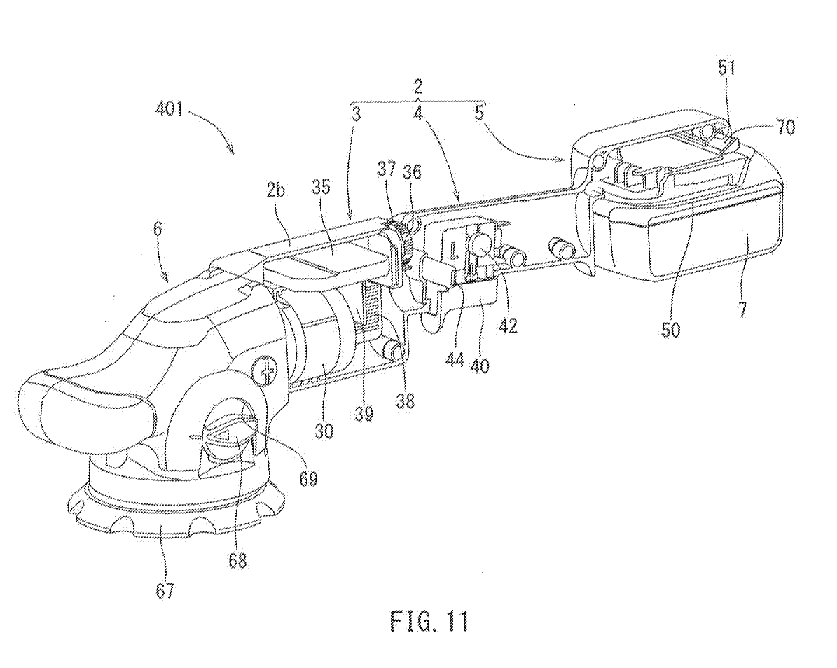

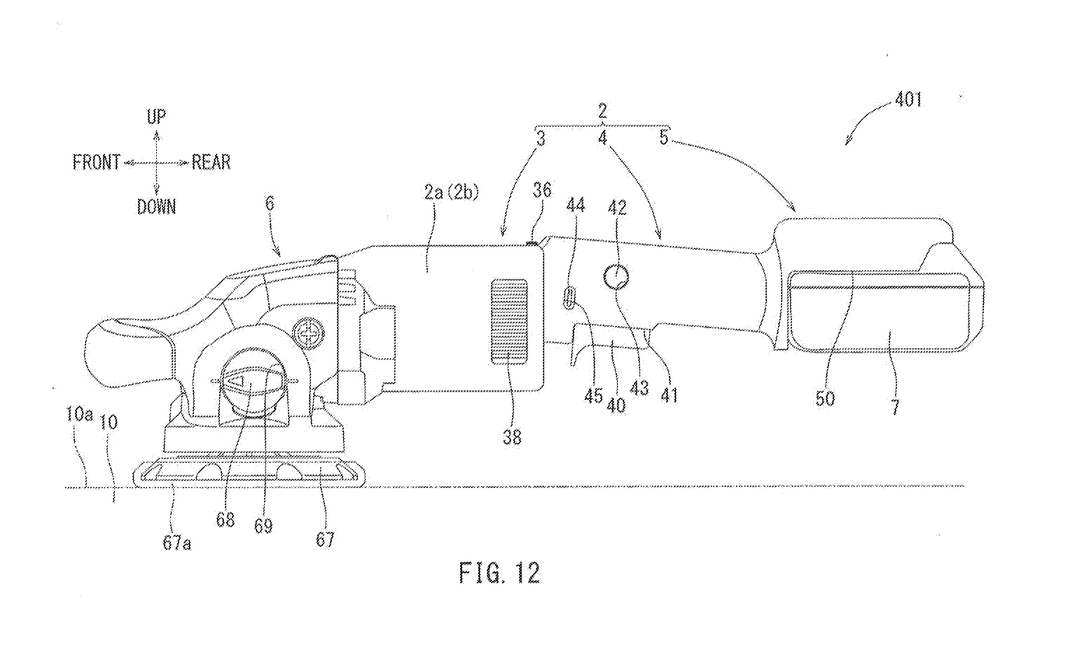

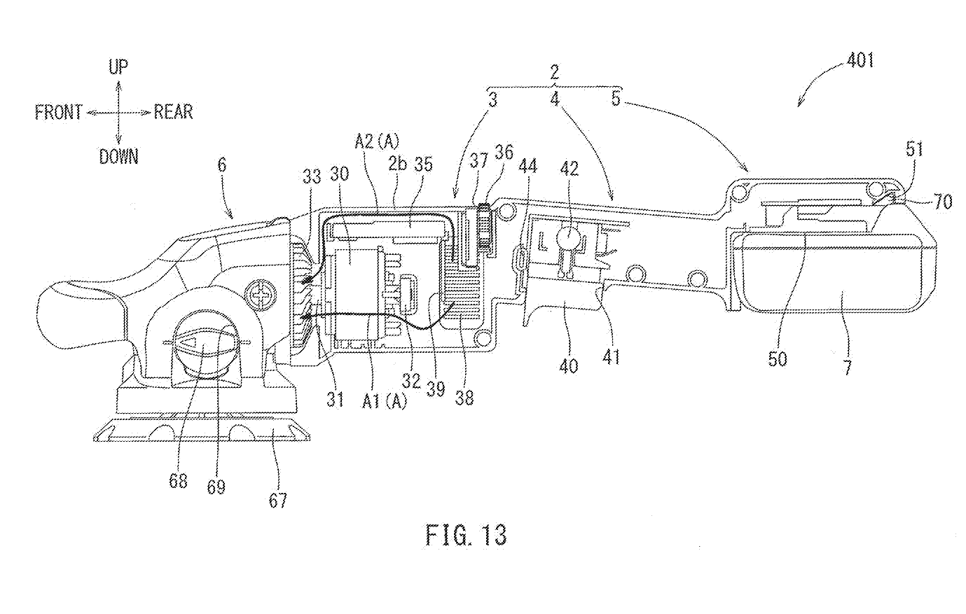

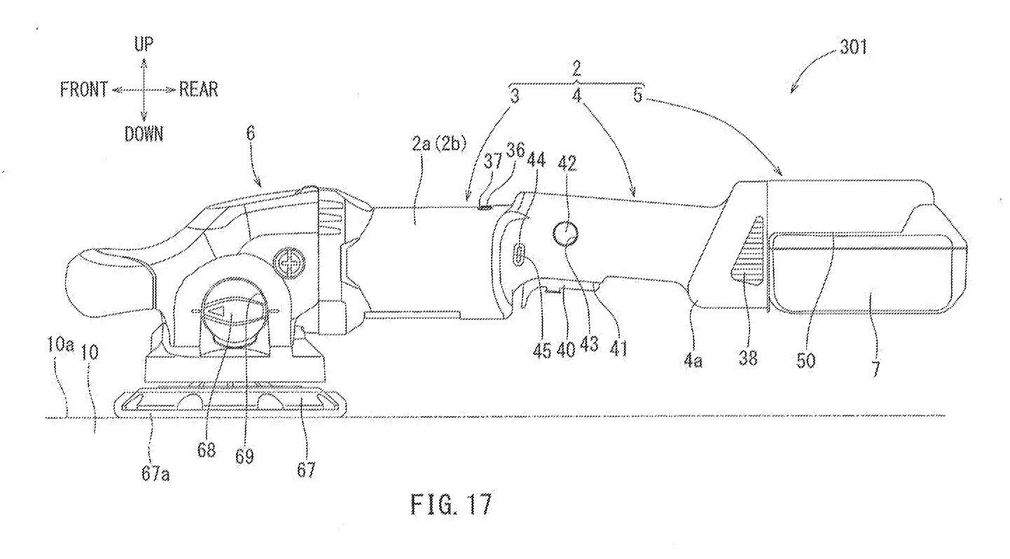

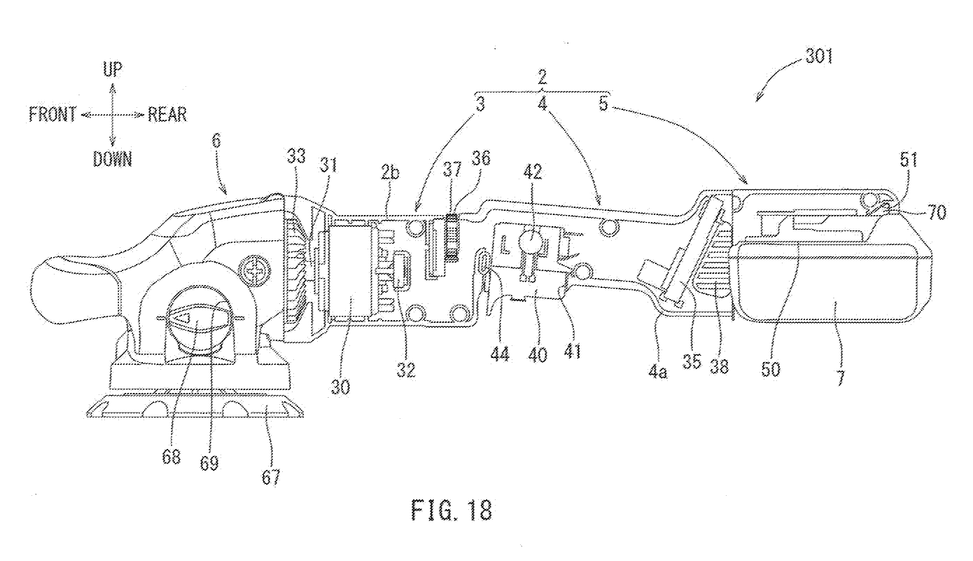

Embodiments of the present disclosure will be described below with reference to FIGS. 1 to 18.

### First Embodiment

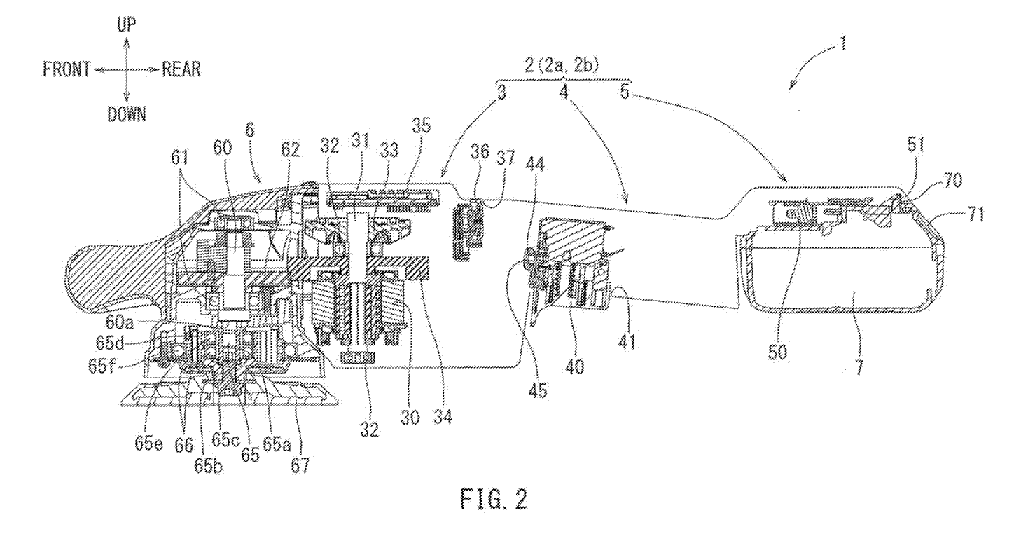

A first embodiment of the present disclosure will be described with reference to FIGS. 1 and 2. In the following embodiments, “a brush 67a”, “a surface 10aof a material 10 to be ground and/or polished (for example, an automobile body)”, “a brushless motor 30”, and “an electrical circuit board of a controller 35” exemplify and serve as examples, respectively, of “a tip end tool”, “a working surface”, “a motor”, and “an electrical circuit board”. Furthermore, the up, down, from, rear, left, and right directions indicated in the legends present in the figures correspond to up, down, front, rear, left, and right directions in the drawings, respectively. This orientation of the directions are not limited to this configuration can be applied in other orientations in other embodiments.

A polisher 1 is a rechargeable electric took for polishing a surface 10a of a material 10 to be polished. Generally, the polisher 1 may include a main body housing 2 and a gear housing 6 that is connected to the front portion of the main body housing 2 tester to FIG. 1). The main body housing 2 and the gear housing 6 will be explained before separately.

First, the main body housing 2 will be explained. The main body housing 2 may include a motor housing 2 that is formed in a large tubular manner (with a large diameter), a handle housing 4 that is consecutively formed on the rear side of the motor housing 3 in a small tubular manner (with a smaller diameter), and a battery housing 5 that is continuously extends from and is formed on the rear side of the housing 4. The main body housing 2 may be formed by combining a left-half split housing 2a with a right-half split housing 2b by inserting a plurality of screws (not shown) lines these housings 2a, 2b at predetermined positions.

As shown in FIGS. 1 and 2, a brushless motor 30 may be assembled on the front side of the interior of the motor housing 3 in a vertical manner (within its axis of rotation to the vertical up-down axis, when the polisher is oriented with the brush 67a flush against the surface 11aof the material 10 to be polished). In more detail, the brushless motor 30 may be assembled on the front side of the interior of the motor housing 3 such that a motor shaft 31 thereof is disposed in an up-to-down direction. A load-side (upper side) of the rotor shaft 31 and an anti-load side (lower side) of the rotor shaft 31 may be respectively supported by bearings 32. Because of this support configuration, the motor shaft 31 may rotate in a smooth manner.

Furthermore, a cooling fan 32 may be attached on the shaft 31, at the load-side of said shaft 31. Accordingly, when the brushless motor 30 rotates, the cooling fan 35 may rotate together synchronously with the rotor shaft 31. Due to the presence of the cooling fan 33, the brushless motor 30 may be cooled by the driving force of the motor itself, without having to use an external driving force. Furthermore, a gear 34 (a helical gear in this embodiment) may be attached to the load-side of the rotor shaft 31.

Furthermore, a rectangular thin-plate-shaped controller 35 may be assembled on the front side of the interior of the motor housing 3. In more detail, the controller 35 may be assembled on the front side of the interior of the motor housing 3 so as to be disposed above and parallel to the brushless motor 30 in a direction in which the main body housing 2 extends (in a front-to-rear direction), perpendicular to the rotation axis of the motor 30. In other words, the controller 35 may be assembled on the front side of the interior of the motor housing 3 so as to be spaced apart with respect to the brushless sensor 30 in the up-to-down direction and overlapping with respect to the brushless motor 30 in the front-to-rear direction.

The controller 35 may include FET elements which control the brushless motor 30 and an electrical circuit bound (both not shown). The FET elements and the electrical circuit board may be molded by resin martial having a high insulation property.

A dial 36 by which the rotation speed of the brushless motor 30 can be adjusted may be assembled on the rear side of the interior of the motor housing 3. In more detail, the dial 36 may be assembled such that the dial 36 fits into, and an upper part of the dial 36 extends from, a cutout portion 37 that is formed on the upper side of the motor housing 3. Because of this dial configuration, a user can operate the dial with his or her thumb while holding the handle housing 4. Thus, due to the thumb apparatus capacity, the user can operate the dial 36 simultaneously while polishing, without any interruption.

An exhaust port (not shown) may be formed on the front side of the motor housing 3 (in the vicinity of the cooling fan 33). Furthermore, a right air inlet port 38 and a left air inlet port 38 may be formed on the rear side of the motor housing 3 in a paired manner. As shown in FIG. 1, the inlet ports 38 may be formed in a rectangular-shaped manner with a grill consisting of front-rear segments spanning the inlet port vertically spaced apart at regular intervals placed within the rectangular shape of the inlet port 38, in the up-down front-rear directional plane. Because of this structural configuration of the inlet ports, foreign material can be prevented from entering into the motor housing 3 through the inlet ports 38.

A trigger 40 may be assembled on the front side of the handle housing 4. A user can driver/stop the brushless motor 30 by manually operating the trigger 40. In more detail, the trigger 40 may be assemble don the front side of the interior of the handle housing 4 such that the trigger 40 fits into, and a lower part of the trigger 40 (an operation portion) extends from, a cutout 41 that is formed on the bottom side of the handle housing 4. Because of this structural configuration of the trigger, the user can pull/push the trigger 40 by using his or her index finger while holding the handle housing 4.

A lock-on switch 42 for keeping the trigger 40 held on a pulled position may be assembled on the front side of the handle housing 4. In more detail, the lock-on switch 42 may be assembled on the front side of the interior of the handle housing 4 such that the lock-on switch fits into, and a part of the lock-on switch 42 (an operation portion) protrudes outward (to the left) from a cutout 43 (not shown in FIGS. 1 and 2) that is formed on the left side of the handle housing 4. Because of this lock-on switch configuration, the user can operate the lock-on switch 42 by using his or her (thumb simultaneously while holding the handle housing A.

Furthermore, a trigger-lock switch 44 for changing operation modes of the trigger 40 may be assembled on the front side of the handle housing 4. In more detail, the trigger-lock switch 44 may be assembled on the front side of the interior of the handle housing 4 such that the trigger-lock switch fits into, and a part of the trigger-lock switch 44 (an operation portion) extends from (to the left) a cutout 45 that is formed on the left side of the handle housing 4. Because of this trigger-lock switch configuration, the user can operate the trigger-lock switch 44 using his or her thumb simultaneously while holding the handle housing 4. The modes of the trigger 49 may include a strong power mode, a neutral power mode, and a weak power mode.

In the strong power mode, a current limiter may be interrupted in an electric circuit of the brushless motor 30. In other words, the current limiter may be temporarily disabled so as to not work in the strong power mode. Thus, when the trigger-lock switch 44 is set to the strong power mode, a polishing work can be performed with a larger amount of current, and this power to the motor, resulting in more powerful output at the brush 37a. In the neutral power mode, the current to the motor, and hence power, is neutralized, where the brushless motor 30 will not run even if the user pulls the trigger 40. Because of this neutral power mode configuration, when the trigger-lock switch 44 is set to the neutral mode, any malfunction of the polisher 1 (erroneous driving of the brushless motor 300 can be prevented while the user is carrying the polisher 1.

In the weak power mode, the current limiter may be activated and act on the electric circuit of the brushless motor 30 (in other words the current limiter may be configured to be enabled), such that it controls the current supplied to the motor in accordance with a predetermined current threshold value. Because of this weak power mode configuration, when the trigger-lock switch 44 is set to the weak power mode, the polishing work can be performed by weaker current to the motor, resulting in less powerful output at the brush 67a. As described earlier, the handle housing 4 may be formed in a small tubular manner, and thus the user can easily hold the handle housing 4.

An attachment portion 40 may be formed on the battery housing 5 such that a battery pack 7 can be inserted into said housing 4 from the rear of the housing towards the front. A recess hole 51 may be formed on the battery housing 7. With a protruding portion at its upper surface formed in a shape complementary to this recess hole 51, an engagement claw 70 which can be engaged with the recess hole 51 may be formed on the battery pack 7. Because of this engagement configuration, when the battery pack 7 is attached to the attachment portion 50 of the battery housing 5, the engagement claw 70 of the battery pack 7 may engage with the recess hole 51 of the battery housing 5 in a manner so as to securely attach the battery pack 7 to the housing 5. Thus, upon insertion of the battery pack, an attachment state of the battery pack 7 can be maintained. In other words, the state in which the battery pack 7 is attached to the battery housing 5 may be locked (maintained).

When a release button 61 of the battery pack 7 is operated, the secure attachment engagement of the engagement claw 70 of the battery pack 7 with respect to the recess hole 51 of the battery housing 5 may be released. Thus, upon being released by pressing of the release button 71, the battery pack 7 that has been attached to the attachment portion 50 of the battery housing 5 can be removed from the battery housing 5 by being slid from the front to the rear. In other words, upon being released the battery pack 7 can be easily be taken out and exchanged with anew one. As described above, the main body housing 2 may include the motor housing 4, the handle housing 4, and the battery housing 5. In this configuration, the main body housing 2 may extend in a front-to-rear direction perpendicular to the up-to-down direction of the output shaft 65 that is discussed infra.

Next, the gear housing 6 will be explained below (refer to FIG. 2). An intermediate shaft 60 may be assembled on the upper side of the gear housing 6. In more detail, the intermediate shaft 60, parallel to the output shaft and overlapping with it in the front-to-rear and up-to-down directions may be assembled at the upper-front region of the interior of the gear housing 6 such that a rotational axis direction thereof extends in the up-to-down direction. The intermediate shaft 60 may be supported by bearings 61 on the load-side (lower side) thereof as well as on the anti-load-side (upper side) thereof. Because of this configuration, the intermediate shaft 60 may rotate in a smooth manner.

A gear 62 (a helical gear in this embodiment) that can engage with the gear 34 (helical in this embodiment) of the brushless motor 30 may be fitted on the intermediate shaft 60 at approximately the central region of the shaft 60 height wise in the up-to-down direction, Due to this structural configuration including the interlocking gears 62 and 34, when the brushless motor 30 is driven, the intermediate shaft 60 may rotate in accordance with the rotation of the rotor shaft 31, where both shafts rotate synchronously. A final output shaft 65 may be attached to a tip end surface 60a of the intermediate shaft 60.

Due to the above structural configuration, where the final output shaft extends downward from the peripheral surface of the intermediate shaft 60, the output shaft 65 may rotate in accordance with rotation of the intermediate shaft 60 about its vertical rotational axis. The output shaft 65 that is assembled in this manner may be disposed perpendicular to a surface 10a of the material 10 to be polished, and rotate around the vertical rotational axis of the intermediate shaft 60. In particular, the output shaft 65 may be assembled to the tip end surface 60a of the intermediate shaft 60 such that its axial center is disposed in an eccentric manner, on the radial outer periphery of the tip end surface 60a, from the central axis of rotation of the intermediate shaft 60, b a predetermined length. Around the outer radial peripheral surface of the output shaft 65, a connection shaft 65b concentric with the output shaft 65 may be rotatable and coaxially supported by output shaft 65 via a sleeve 65a and bearings 66. A circular base 67 may be fixed to the lower end of the connection shaft 65b by use of a bolt 65c.

A brush 67a for polishing the surface 10aof the material 10 to be polished may be attached to the lower surface of the base 67. A spur gear 65d may be provided fitted around the connection shaft 65b such that teeth thereof extend in an outer radial peripheral direction. Furthermore, an internal gear 65e may be rotatably provided, that is concentric with the intermediate shaft 65, and is supported via a bearing 65f such that the internal gear 65e faces the spur gear 65d.

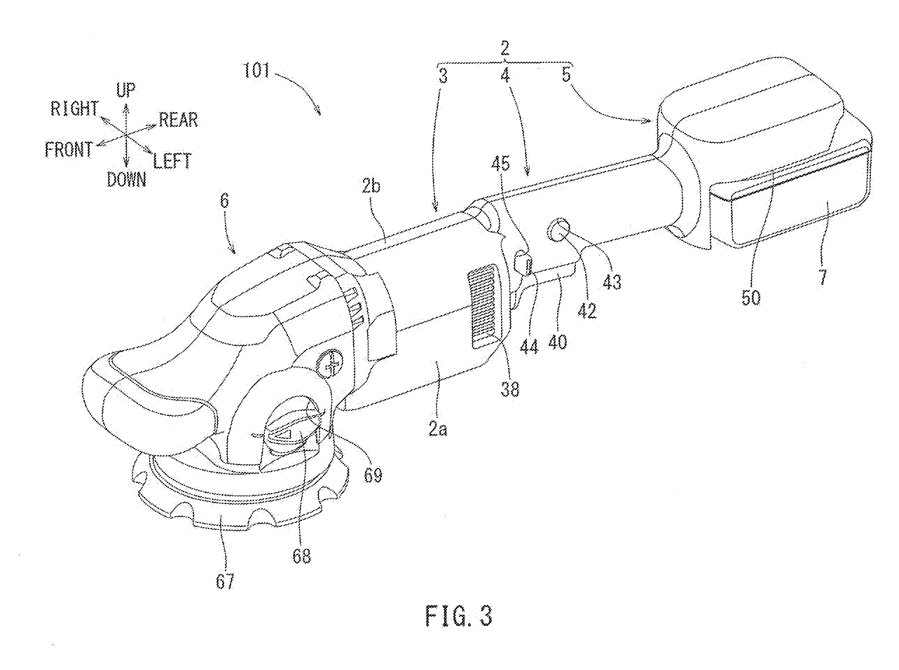

The internal gear 65c may be configured such that it engages with the teeth of the spur gear 65d in an orientation where the output shaft 65 is eccentric relative to the axial center of rotation of the intermediate shaft 60. A rotation state of the brush 67a attached to the base 67 may be changed by switching between a state where rotation of the internal gear 65e is allowed and a state where it is restricted. (In more detail, by inserting a pin (not shown) fixed to the mode selection switch 68 into the internal gear 65e, or by alternately removing the pin from the internal gear 65e, rotation of the internal gear 65c may be restricted or allowed, respectively.) These two states can be switched by manually rotating the mode selection switch 68 shown in FIGS. 1 and 3. The mode selection switch 68 may be assembled on the left side of the gear housing 6 such that the mode selection switch fits in, and a part of the mode selection switch 68 (an operation portion) extends to the left from a cutout 69 that is formed on the left side of the gear housing 6.

When the mode selection switch 68 is switched to “a forcible rotation mode”, which is shown in the figures, rotation of the internal gear 65e may be locked. In this case, the base 67 together with the fitted brush 67a collectively may revolve around the central axis of rotation of the intermediate shaft 60 wherein the base 67 and brush 67a rotate about the axis of the output shaft 65 in a forcible manner, while the output shaft 65 due to its eccentric placement to the outer radial peripheral surface of tip end surface 60a revolves around the central axis of rotation of intermediate shaft 60, thereby performing a rapid polishing work. When the mode selection switch 68 is switched to “a free rotation mode”, which can be made by rotating the mode selection switch 68 by about 180° in a clockwise direction, rotation of the internal gear 65e may be allowed.

In this “free rotation mode”, the internal gear 65e may automatically rotate or stop according to the degree to which the brush 67a receives an opposing, frictional, force from the surface 10aof the material 10 to be polished, thereby performing a polishing work such that a clearer polishing surface can be accomplished. In this embodiment, the gear housing 6 may be arranged such that the gear housing 6 may be accomplished. In this embodiment, the gear housing 6 may be arranged such that the gear housing 6 may be disposed on the front side of the brushless motor 30 as described above.

Next, an operation of the polisher 1 will be explained below. when the user pulls the trigger 40 to drive the brushless motor 30, the intermediate shaft 60 may rotate in a synchronous manner, in accordance with the rotation of the rotor shaft 31, due to the interlocking of gears 34 and 62, as explained above. The output shaft 65, in turn, may revolve around intermediate shaft 60, in a synchronous manner, and in accordance with the rotation of the intermediate shaft 60, where the base 67 and fitted brush 67a fixed to the output shaft 65 may rotate independently as ell, as described above. In this way, a polishing work on the surface 10a of the material 10 to be polished can be performed. When the mode selection switch 68 is switched to the forcible rotation mode, the base 67 as well as the brush 67ado not rotate independently, and collectively revolve around the central axis of rotation of intermediate shaft 60, thereby performing a rapid polishing work.

When the brushless motor 30 is driven, the cooling fan 33, due to being fitted on shaft 31, may also rotate in accordance with the rotation of the rotor shaft 31, and rotate to the same degree, along the same rotational axis. Due to rotation of the cooling fan 33, outside air (not shown (is sucked in through the inlet ports 38, and simultaneously the outside air may be discharged through the exhaust port. In other words, continuous air flow from the inlet ports 38 and toward the exhaust port may be generated by rotation of the coding fan 33. During this flow, the outside air may pass into and through the controller 35, thereby efficiently cooling the controller 35.

Furthermore, as discussed above, the controller 38 may be assemble don the front side of the interior of the motor housing 3 such that it is disposed above and parallel to the brushless motor 30 in a front-to-rear direction where the main body housing 2 extends. In other words, the controller 35 may be assembled on the front side of the interior of the motor housing 3 above the cooling fan 33. Because of this configuration, the air flow path generated by the cooling fan 33 may include air flow blowing toward and through the breadth of controller 35 in a sufficient manner, thereby efficiently and sufficiently cooling the controller 35.

The polisher 1 according to the first embodiment may be configured as discussed above. According to this configuration, the controller 35 may be assembled on the front side of the interior of the motor housing 3 such that it is disposed above and parallel to the brushless motor 30 in a front-to-rear direction where the main body housing 2 extends (in the front-to-rear direction). In other words, the controller 35 may be assembled on the front side of the interior of the motor housing 3 such that the controller 35 overlaps with the brushless motor 30 in the front-to-rear direction and left-to-right direction while being spaced apart in the up-to-down direction. Because of this space-efficient configuration, even if the controller 35 is disposed in the main body housing 2, excessive elongation of the polisher 1 can be prevented in the front-to-rear direction. In other words, even if the controller 35 is present, the total length of the polisher 1 can be prevented from increasing, where the parallel nature of the controller and the brushless motor minimize the front-to-rear length of the polisher. In addition, when the controller 35 is assembled in this manner, the air flow that is generated by driving the brushless motor 30 may pass through the controller 35 in a sufficient manner, thereby sufficiently and efficiently cooling the controller 35.

### Second Embodiment

A second embodiment will be explained below with reference to FIGS. 3 to 6. In comparison with the polisher 1 according to the first embodiment, the polisher 101 of the second embodiment is configured such that the brushless motor 30 is horizontally disposed. In other words, theorbo shaft 31, and therefor the rotational axis of said brushless motor, may be disposed in the front-to-rear direction in which the main body housing 2 extends. In the following explanation, descriptions of the embers and configurations that do not need to be modified and are in common with the first embodiment are omitted by one of the same reference numerals. This will be applied to other embodiments and also reference embodiments described below.

A polisher 101 is a rechargeable electric tool for polishing the surface 10a of the material 10 to be polished. In the same way as the polisher 1, the polisher 101 may generally include the main body housing 2 and the gear housing 6 that is connected to a front portion of the main body housing 2 (refer to FIGS. 3 to 6).

As discussed above, the brushless motor 20 may be assembled on the front side of the internal of the motor housing 3 of the main body housing 2 of the polisher 101 such that it is disposed in a horizontal direction. In other words, the rotor shaft 31 of the brushless motor 30 of the polisher 101 may extend in the front-to-rear direction.

Because the brushless motor 39 is assembled in this manner, a bevel gear may be used as the gear 34 on the load-side (front-side) of the rotor shaft 31 (not shown in FIGS. 3 to 6) and the gear 62 of the intermediate shaft 60 (also not shown in FIGS. 3 to 6), respectively.

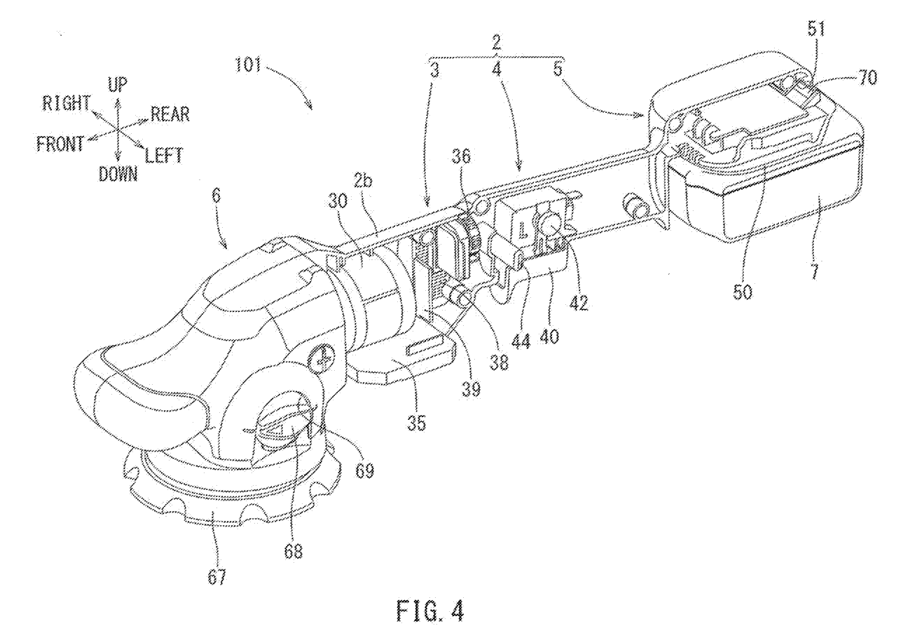

The controller 35 of the polisher 101 may be assembled in the interior of the motor housing 3 below and in perpendicular to the axis of rotation of the brushless motor 30, in the front-rear left-right directional plan, wherein it extends outward in both of these directions as compared to the brushless motor 30, as shown in FIG. 4. In other words, as well as the controller 35 in the polisher 1, the controller 35 in the polisher 101 may be assembled on the front side of the interior of the motor housing 3 such that it overlaps with the brushless motor 30 in the front-to-rear and left-to-right directions, and may be spaced apart in the up-to-down direction. Furthermore, a rib 39 may be disposed on the front side of the inlet ports 38 in the motor housing 3 of the polisher 101 in the up-to-down direction. The polisher 101 may be configured as described above.

Next, an operation of the polisher 101 will be explained below. In the polisher 101 as well as in the polisher 1, when the user pulls the trigger 40 to drive the brushless motor 30, the intermediate shaft 60 may rotate synchronously, in accordance with rotation of the rotor shaft 31. The output shaft 65, in turn, may rotate synchronously with the rotation of the intermediate shaft 69, and thus the base 67 as well as its fitted brush 67a may collectively rotate. In this way, a polishing work to the surface 10a of the material 10 to be polished can be performed.

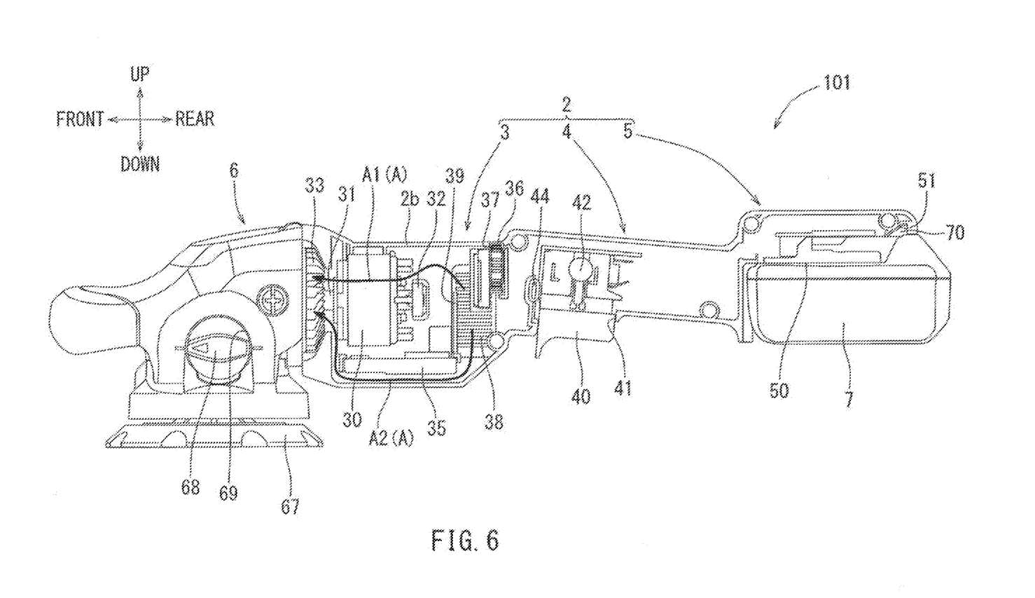

When the brushless motor 30 is driven, the cooling fan 33 fitted on the motor's rotor shaft, with the same front-to-rear axis of rotation, may also rotate in accordance with rotation of the rotor 31. As shown in FIG. 6, by said rotation of the cooling fan 33, outside are A may be sucked in through the inlet ports 38 and discharged through the exhaust port. In other words, continuous air flow of the outside air A from the inlet ports 38 and toward the exhaust port may generated by rotation of the cooling fan 33. During this generation of air flow, the outside air A may include air flow blowing toward and through the breadth of controller 35 in a sufficient manner, thereby efficiently cooling the controller 35, as shown in FIG. 6.

Furthermore, as shown in FIG. 6, because of the presence of the rib 39, the outside air A that flows from the inlet ports 38 toward the exhaust port may be separated into two separate air flows in an upper and a lower direction, i.e., into an upper air flow A1 and a lower air flow A2, where both paths are shown in FIG. 6. Because of this air flow configuration, the brushless motor 30 and the controller 25 may be sufficiently and effectively cooled by the upper air flow A1 and the lower air flow A2, respectively.

The polisher 101 according to the second embodiment may be configured as discussed above. According to this configuration, the controller 35 in the polisher 101 may b reassembled in the interior of the motor housing 3 such that it is disposed below an perpendicular to the front-to-rear axis of rotation of the brushless motor 39. In other words, as swell as the controller 35 of the polisher 2, the controller 35 of the polisher 101 may be assembled on the front side of the interior of interior housing 3 such that the controller 35 overlaps with the brushless motor 30 in the front-to-rear and left-to-rear directions, and is spaced apart from the motor 20 in the up-to-down direction. Because of this configuration, even if the controller 35 is disposed in the main body housing 2, the length of the polisher 101 can be minimize din the front-to-rear direction in a space-efficient manner. In other words, even if the controller 35 is present, a total length of the polisher 101 can be restrained. In addition, when the controller 35 is assembled in this manner, the air flow that is generated by driving the brushless motor 30 may be separated into the upper air flow A1 and the lower air flow A2 by the rib 38, and the lower air flow A2 may pass through the controller 35 in a sufficient manner, thereby sufficiently and efficiently cooling the controller 35 of the polisher 101. In this way, the same effect as the polisher 1 may be obtained in the polisher 101.

### Third Embodiment)

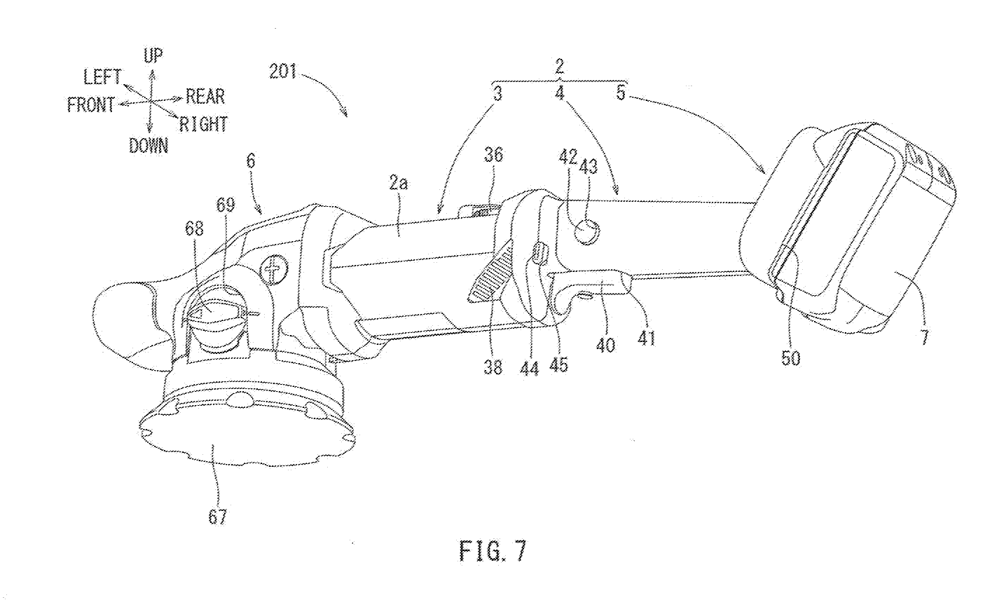

Next, a third embodiment of the present disclosure wall be explained with reference to FIG. 7 to 9. In comparison with the polisher 101 of the second embodiment that is already discussed above, a polisher 201 may be configured such that the controller 35 may be assembled on the rear side of the brushless motor 30 in an oblique non-parallel manner. the polisher 201 is a rechargeable electric tool for polishing the surface 10a of the material 10 to be polished, and the polisher 201 may generally include the main body housing 2 and the gear housing 6 that is connected to the front portion of the motor housing 3 of the main body housing 2 (refer to FIG. 7 to 9).

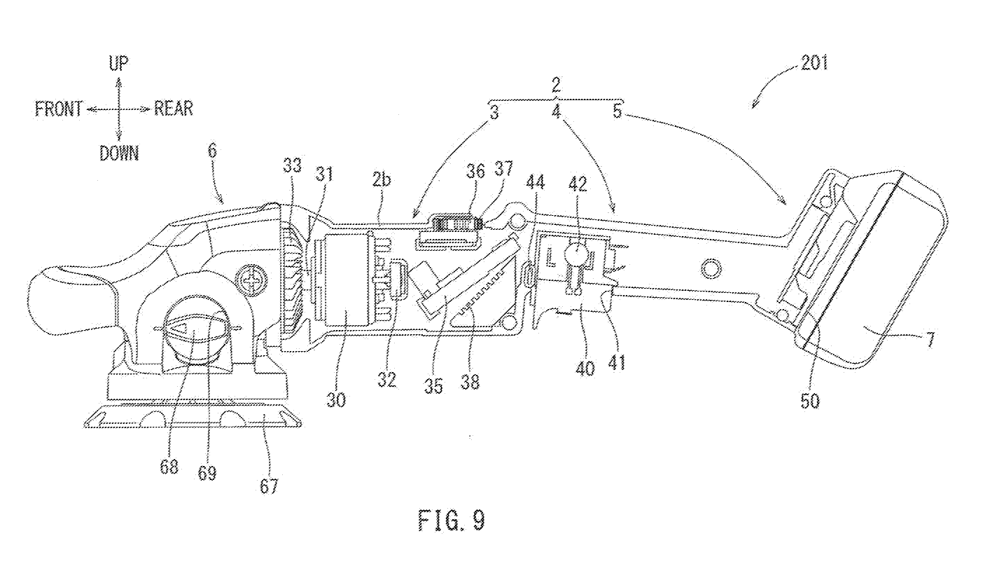

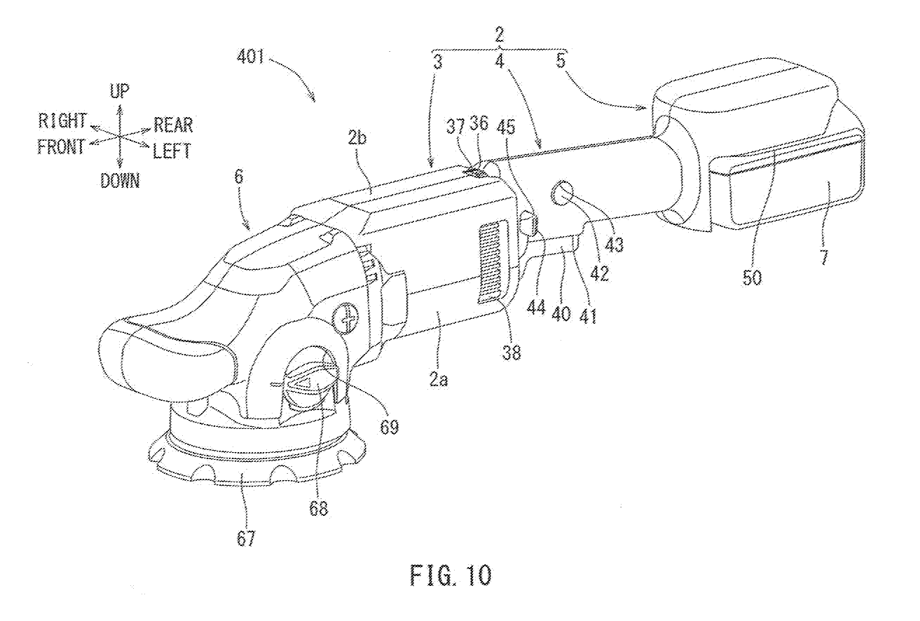

The controller 35 in the polisher 201 may be assembled in the interior of the motor housing 3 to the rear of the brushless motor 30. Furthermore, as shown in FIG. 9, the controller 35 may be assembled so as to be tilted in an oblique manner in the front-to-rear direction. In particular, the controller 35 may be tilted upwards (traversing downward-to-upward) as it extends in the frontward-to-rearward direction. In this configuration, the controller 36 may face the obliquely laid inlet ports 38 in a roughly parallel manner, to achieve maximum cooling from inflow of air, as shown in FIG. 9. The polisher 201 may be configured as described above.

Next, an operation of the polisher 201 will be explained below. In the polisher 291 as well as in the polisher 1, when the user pulls the trigger 40 to drive the brushless motor 30, the intermediate shaft 60 may rotate synchronously, in accordance with rotation of the rotor shaft 31. The output shaft 65 may revolve in turn in accordance with rotation of the intermediate shaft 60, and thus the base 67 as well as its fitted brush 67a may rotate accordingly. In this way, a polishing work to the surface 10a of the material 10 to be polished can be performed.

When the brushless motor 30 is driven, the cooling fan 33 may also rotate in accordance with rotation of the rotor 31 as is present on the rotor shaft and shares the same axis of rotation as brushless motor 20. Due to rotation of the cooling fan 33, outside air (not shown( may be sucked in through the inlet ports 38 and discharged through the exhaust port. In other words, continuous air flow from the inlet ports 38 and toward the exhaust port may be generated by rotation of the cooling fan 33. During this flow, the outside air may include air flow blowing toward and through the breadth of controller 35 in a sufficient manner, thereby efficiently cooling the controller 35.

As discussed above, the controller 35 may be assembled so as to face the inlet ports 83. Because of this configuration, the air flow may pass through the controller 35 in a sufficient and efficient manner, and thus the controller 35 can be sufficiently and efficiently cooled.

The polisher 201 according to the third embodiment ma be configured as discussed above. According to this configuration, the controller 35 in the polisher 201 may be assembled in the interior of the motor housing 3 such that it is disposed at the rear of the brushless motor 30. Furthermore, the controller 35 may be assembled so as to be titled obliquely in the front-to-rear direction, so as to be titled downwards-to-upwards as it extends in the rearward-to-frontward direction. Because of this configuration, even if the controller 35 is disposed in the main body housing 2, the overall length of the polisher 291 can be restrained in the front-to-rear direction. In other words, even if the controller 35 is present, due to its oblique placement on top of the inlet ports and to the rear of the motor, a total length of the polisher 201 can be prevented from increasing. In addition, when the controller 35 is assembled in this manner, the air flow that is generated by driving the brushless motor 30 may pass through the controlled 35 in a sufficient manner, thereby sufficiently and efficiently cooling the controller 35. In this way, the same effect as the polisher 101 may be obtained in the polisher 201.

### Fourth Embodiment

Next, a fourth embodiment of the present disclosure may be explained with reference to FIGS. 10 to 13. In comparison with the polisher 101 of the second embodiment that is discussed above, while the controller 35 of the second embodiment is disposed on the lower side of the brushless motor 30, the controller 35 of the fourth embodiment conversely may be disposed above the brushless motor 30, on its upper side. The polisher 401 is a rechargeable electric tool for polishing the surface 10a of the material 10 to be polished, and the polisher 401 may generally include the main body housing 2 and the gear housing 6 that is connected to the front portion of the motor housing 3 of the main body housing 2 (refer to FIG. 10 to 13). The polisher 401 may be configure das described above. In the polisher 401, the same effect may be obtained as the polisher 101.

It is noted that the present teaching are not limited to the above-described embodiments, and it is understood that variations and modifications may be effected without departing from the spirit and scope of the present teachings.

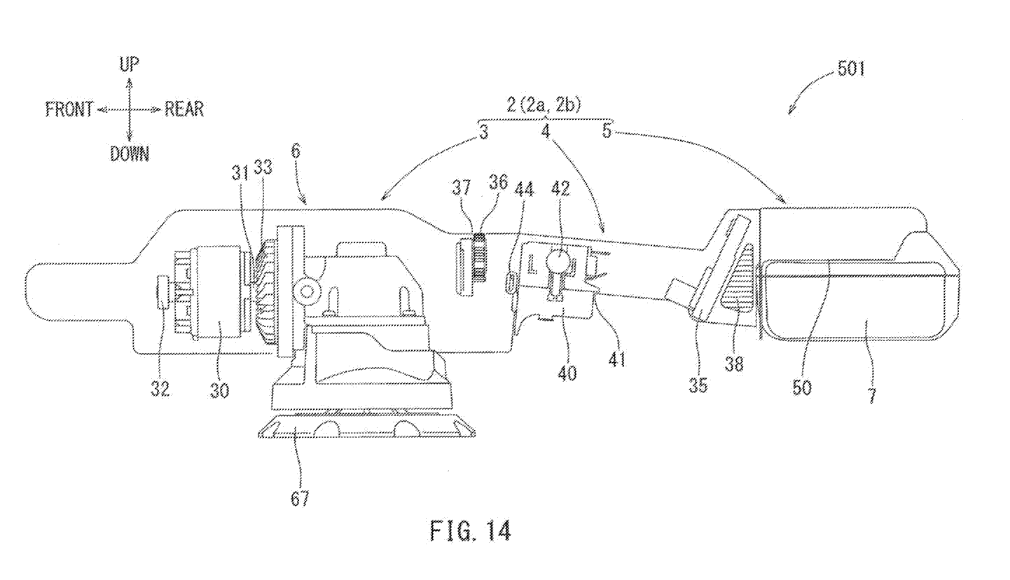

In the first to fourth embodiments, the gear housing 6 is disposed on the front side of the main body housing 2. However, the arrangement of the gear housing 6 is not limited to this configuration. For example, the gear housing 6 may be disposed at the rear side of the motor housing 3 and on the front side of the handle housing 4, as shown in a polisher 501 of FIG. 14 (a further embodiment).

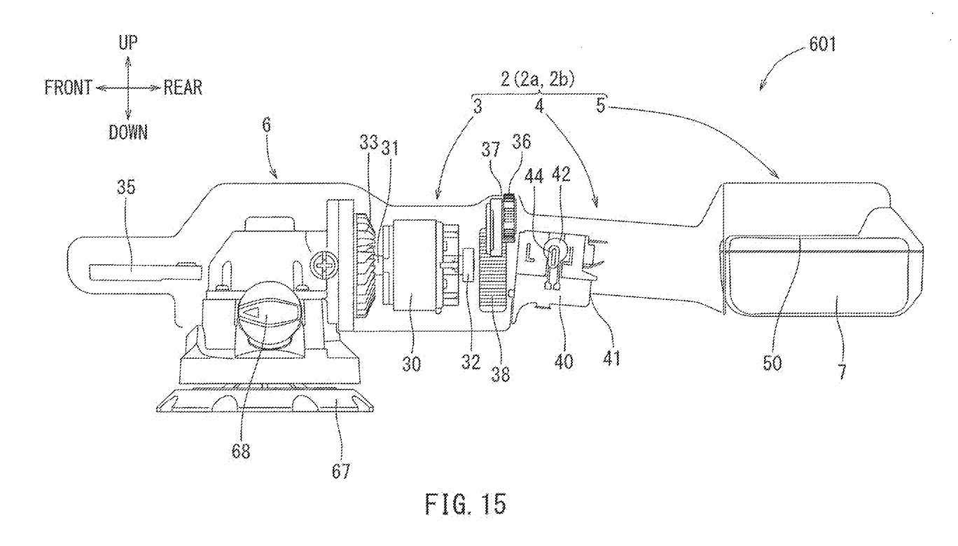

In the polisher 101 according to the second embodiment, the controller 35 may be assembled below and perpendicular to the axial direction of rotation of the brushless motor 30 in the interior of the motor housing 3. In other words, the controller 35 may be assembled on the front side of the interior of the motor housing 3 such that it is overlaps with respect to the brushless motor 30 in the front-to-rear and left-to-right directions. However, an arrangement of the controller 35 may not be limited to this configuration. The controller 35 may be assembled in the front-to-rear direction in the interior of the gear housing 6, as the very front of the polisher, as shown in the polisher 601 of FIG. 15 (another further embodiment).

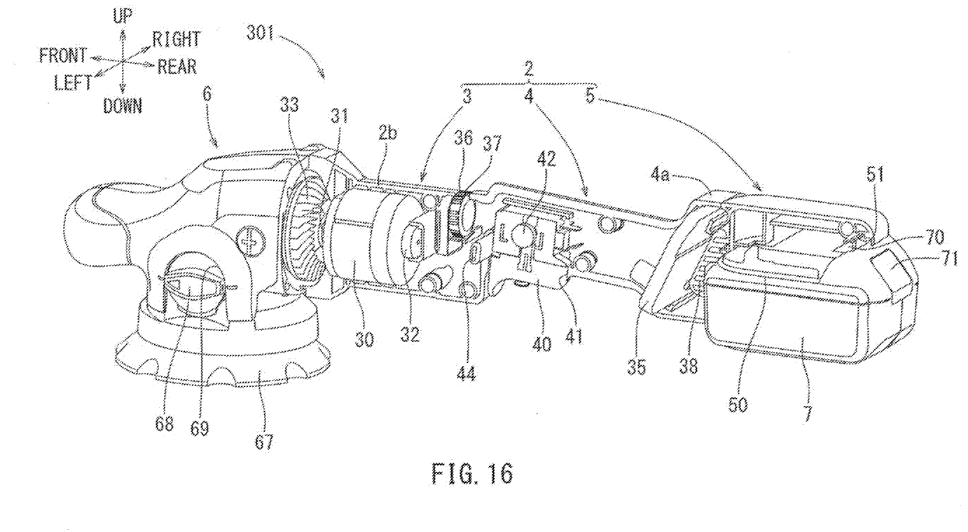

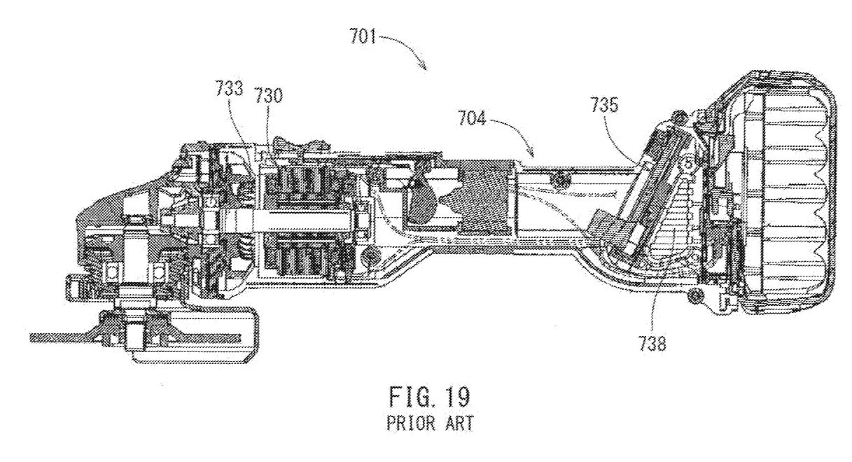

Next, another further embodiment of the present disclosure will be explained with reference to FIGS. 16 to 19. In comparison with the polisher 201 of the third embodiment that is already discussed above, a polisher 301 may be configured such that the controller 35 may be assemble don the more rear side that in the third embodiment. The polisher 301 is a rechargeable electric tool for polishing the surface 10a of the material 10 to be polished, and the polisher 301 may generally include the main body housing 2 and the gear housing 6 that is connected to the front portion of the main body housing 2 (refer to FIG. 16 to 18).

The controller 301 in the polisher 301 may be assemble dint he interior of the handle housing 4, in more detail, in an extension portion 4a formed on the rear side of the handle portion 4. As shown in FIG. 16, the extension portion 4a may be configured such that the controller 35 is attached to the extension portion 41 so as to be titled in the front-to-rear direction, in more detail, to be tilted upwards as it extends in the rearward direction, as well as the controller 35 in the polisher 201. Furthermore the inlet ports 38 of the polisher 301 may be formed on the rear side of the extension portion 4a of the handle housing 4. Because of this configuration, the controller 35 of the polisher 301 may face the inlet ports 38. The polisher 301 may be configured as described above.

Next, an operation of the polisher 301 will be explained below. In the polisher 301 as well as in the polisher 1, when the user pulls the trigger 401 to drive the brushless motor 30, the intermediate shaft 60 may rotate in accordance with rotation of the rotor shaft 31. The output shaft 65 may rotate in accordance with rotation of the intermediate shaft 60, and thus the base 67 as well as the brush 67a may rotate. In this way, a polishing work to the surface 10a of the material 10 to be polished can be performed.

When the brushless motor 30 is driven, the cooling fan 33 may also rotate in accordance with rotation of the rotor 31. By rotation of the cooling fan 33, outside air (not shown) may be taken through the inlet port 38 and discharged through the exhaust port. In other words, air flow from the inlet ports 38 toward the exhaust port may be generated by rotation of the cooling fan 33. During this flow, the outside air may pass through the controller 35, thereby cooling the controller 35.

the polisher 301 according to this embodiment ma be configured as discussed above. According to this configuration, the controller 35 in the polisher 391 may be assembled in the interior of the handle housing 4, in more detail, in the extension portion 4a that is formed in the rear side of the handle housing 4. Furthermore, the controller 35 may be assembled so as to be tiled in the front-to-rear direction, in more detail, so as to be tilted upwards as it extends in the rearward direction. When the controller 35 is assembled in this manner, the air flow that is generated by driving the brushless motor 30 may pass through the controller 35, thereby cooling the controller 35.

In the polisher 201 according to the third embodiment, the controller 35 may be assembled such that the controlled 35 is tilted obliquely in the front-to-rear direction as it extends rearward. However, an arrangement of the controller 35 is not limited to this configuration. The controller 35 may be tilted in the front-to-rear direction as it extends in the forward direction (that is it may extend upward to downward as it traverses in the front-to-rear direction). Alternatively, the controller 35 may be disposed perpendicular to the front-to-rear direction.

In the polishers 1, 101, 201 and 401 according to the first to the fourth embodiments and the polishers 301, 501 and 601 according to another embodiments, the controller 35 may be exemplified to include the FET elements that control the brushless motor 30 and the electrical circuit board. However, the arrangement may not be limited to this configuration. The controller 35 may include only the electrical circuit board and electrical elements other than the FET elements. In this case, the FET elements may be separately provided.

Furthermore, in the polishers 1, 101, 201 and 401 according to the first to the fourth embodiments and the polishers 301, 501 and 601 according to another embodiments, the electrical circuit board may be exemplified as the circuit board for the controller 35. However, the configuration may not be limited thereto, and various kind of electrical circuit board, for example, an electrical circuit board including LEDs for display may be applied to this disclosure.

Furthermore, in the above embodiments, the main body housing 2 may include the motor housing 3 formed in the large tubular shape, the handle housing 4 that is connectively formed in the small tubular shape on the rea side of the motor housing 3, and the battery housing 5 that is consecutively formed on the rear side of the handle housing 4. However, the configuration may not be limited thereto. For example, the handle housing 4 may be separately formed without being continuously formed and extending from the motor housing 3 of the main body housing 2. Furthermore, the battery housing 5 may be separately formed without being continuously formed and extending from the handle housing 4 of the main body housing 2.

Furthermore, although the above embodiments have been described in connection with the polisher, the above teaching can be applied to any other electric power tools as long as they have tip end tools. For example, the above teachings may be also applied to a grinder that have a grinding wheel as a tip end tool and may basically have substantially the same construction as the polisher. Further, the power tools to which the above teachings can be applied may include, other than the grinder, various angle tools including so-called “multi tools” that are provided with oscillating mechanisms. The angle tools may include an angle impact driver, an angle screw driver, etc. The angle impact driver may have a hammer and an anvil, and the angle screw driver may have a plurality of planetary gear mechanisms.

What is claimed is:

1. Aa electric power tool, comprising:
a tip end tool;
an output shft extending in a direction perpendicular in a work surface;
a main body housing extenidng in a direction perpendicular to the output shaft;
a motor that is housed in the main body housing; and
an electrical circuit board that is disposed parallel to the motor in a direction in which the main body housing extends.

2. An electric power tool comprising:
a motor with a rotor shaft that extends in a front-to-rear direction;
a motor housing that houses the motor;
a gear housing that is disposed at the front side of dm motor;
an output shaft that is held by the gear housing and disposed approximately perpendicular to the rotor shaft;
a handle housing that is disposed at the rear side of the motor housing; and
an electrical circuit board, that is disposed further outward than the outer periphery of the motor.

3. An electric power tool, comprising:
a motor with a rotor shaft that extends in the front-to-rear direction;
a motor housing that houses the motor;
a gear housing that is disposed at the front side of the motor;
an output shaft that is held by the gear housing and disposed approximately perpendicular to the rotor shaft;
a handle housing that is disposed at the rear side of the motor housing; and
an electrical circuit board that is disposed between the motor and the handle housing,
wherein the electrical circuit board is tilted in a front-to-rear direction or disposed in a perpendicular manner with respect to the front-to-rear direction.

4. The electric power tool according to claim 2, wherein there is a rib present extending in the up-to-down direction from around the rear portion of the electrical circuit board, overlapping with the front portion of the inlet ports.

5. The electric power tool according to claim 4, wherein the rib splits air that is inlet into the electric power tool via the inlet ports into two streams, one above the electrical circuit Board, and one below the electrical circuit board.

6. The electric power tool according to claim 3, wherein the electrical circuit board is tilted in an oblique mariner relative to the motor.

7. The electric power tool according to claim 6, wherein inlet ports are disposed at the rear of the electrical circuit board in a rectangular-shaped manner.

8. The electric power tool according to claim 7, wherein the inlet ports are formed in a rectangular-shaped manner, with a grill consisting of front-to-rear segments spanning the inlet port vertically spaced apart at regular intervals within the rectangular shape of the inlet ports, in the up-to-down, front-to-rear directional plane.

9. The electric power tool according to claim 6, wherein the electrical circuit board extends in a downward to upward manner as it is traversed from the front to the rear.

10. The electric power tool according to claim 9, wherein the electrical circuit hoard is roughly parallel to a set of inlet ports, which also lie in approximately the same oblique direction.

11. The electric power tool according to claim 1, wherein the tip end tool comprises a circular base with a fitted brush entirely covering the lower basal surface of said circular base, wherein the top portion of the circular base is fixed to the lower end of a connection shall by a bolt.

12. The electric power tool according to claim 1, wherein the tip end tool comprises a circular base with a fitted brush entirely covering the lower basal surface of said circular base, wherein the top portion of the circular base is fixed to the lower end of a connection shaft, by a bolt, wherein the bolt and connection shaft, as well as the uppermost portion of the circular base lie in the interior of the gear housing, whereas the lower portion of the circular base and tilted brush lie protruding outside the gear housing.

13. The electric power tool according to claim 12, wherein the connection shaft is fitted, circumferentially around the output shaft, with bearings radially in between the connection: shaft and the output shaft for rotation of the connection shaft around the output shaft.

14. The electric power tool according to claim 13, wherein the output shaft is fixed eccentrically on thee tip end surface of an intermediate shaft with respect to the axis of rotation of said intermediate shaft, which is in the up-to-down direction.

15. The electric power tool according to claim 14, wherein the intermediate shaft is fitted. with a helical gear around said intermediate shaft, and wherein the rotor shaft also has a helical gear fitted around the rotor shaft, where both gears overlap in the front-to-rear direction.

16. The electric power tool according to claim 15, wherein both the helical gear around the intermediate shaft and the helical gear around the rotor shaft interact in an interlocking manner so as to synchronously drive fire rotation of the output shaft.

17. The electric power tool according to claim. 16, wherein the rotation of the output shaft is in a circular manner about the central axis of rotation of the intermediate shaft.

18. The electric power tool according to claim 17, wherein a spur gear may be fitted radially around tire connection shall such that teeth thereof extend in an outer radial peripheral direction.

19. The electric power tool according to claim 18, wherein an internal gear may be provided concentric with the output shaft, and is supported via a bearing such that it lies radially outward of the spur gear, and faces the spur gear, engaging the teeth of the spur gear.

20. The electric power tool according to claim 19, wherein due to the presence of the internal and spur gear, frictional feedback from the surface worked on allows the circular base and fitted brush to collectively rotate independently from the rotation of the intermediate shaft, around the axis of the output shaft itself, while the output shaft revolves around the central axis of rotation of the intermediate shaft.
